(19) United States
(12) Patent Application Publication
(10) Pub. No.: US 2015/0131922 A1
(43) Pub. Date: May 14, 2015

(54) METHOD FOR REMOVING NOISE OF IMAGE SIGNAL AND IMAGE PROCESSING DEVICE USING THE SAME

(71) Applicant: Samsung Electronics Co., Ltd., Suwon-Si (KR)

(72) Inventor: Yonatan Shlomo SIMSON, Ramat Gan (IL)

(21) Appl. No.: 14/303,129

(22) Filed: Jun. 12, 2014

(30) Foreign Application Priority Data
Nov. 11, 2013 (KR) 10-2013-0136350

(51) Int. Cl. G06T 5/10

(52) U.S. Cl. CPC G06T 5/10
USPC 382/261

(57) ABSTRACT

A method of removing noise of an image signal includes receiving a first frame and a second frame, generating a spatial filtering frame by performing spatial filtering on the second frame, generating a temporal filtering frame by performing temporal filtering on the first frame, and generating a second filtering frame, using the temporal filtering frame, the spatial filtering frame, and the second frame.

### CROSS-REFERENCE TO RELATED APPLICATION

This application claims priority from Korean Patent Application No. 10-2013-0136350 filed on Nov. 11, 2013 in the Korean Intellectual Property Office, and all the benefits accruing therefrom under 35 U.S.C. 119, the contents of which in its entirety are herein incorporated by reference.

### TECHNICAL FIELD

Example embodiments of the inventive concepts relate to a method of removing noise of an image signal and/or an image processing device using the same.

### BACKGROUND

A frame rate, defined in hertz (Hz), is the number of frames of an image signal displayed on a screen per second. When the frame rate of a transmitted original image signal is different from the frame rate capable of being displayed on an image display device, it is possible to display the image signal on the display device by converting the frame rate using frame rate conversion.

Frame rate conversion is a technique of inserting an intermediate frame between frames of an input original image, which can improve motion blur and motion judder without deteriorating brightness of an image display device. Accordingly, a user can be provided with a smooth image.

### SUMMARY

When an original image signal has noise, there is a limitation in improving motion blur and motion judder, therefore, it may be desirable to filter the noise from the original image signal.

Some example embodiments of the inventive concepts provide a method of effectively removing noise of an image signal.

In one or more example embodiments, the method includes receiving a first frame and a second frame; generating a spatial filtering frame by performing spatial filtering on the second frame; generating a temporal filtering frame by performing temporal filtering on the first frame; and generating a second filtering frame, using the temporal filtering frame, the spatial filtering frame, and the second frame.

Other example embodiments of the inventive concepts provide an image display device that effectively removes noise.

In one or more example embodiments, the image display device includes a frame rate conversion (FRC) unit generating an intermediate frame between a first filtering frame and a second filtering frame; and a noise filter unit generating the second filtering frame by removing noise in a second frame, using both of temporal filtering and spatial filtering.

One or more example embodiments of the inventive concepts provide an image processing device.

In at least one example embodiment, the image processing device includes a buffer configured to store a filtered first frame and an unfiltered second frame; a noise filter configured to temporally and spatially filter the unfiltered second frame to generate a filtered second frame; and a frame rate converter configured to generate an intermediate frame in a sequence between the filtered first frame and the filtered second frame.

In at least one example embodiment, the sequence of the filtered first frame and the filtered second frame are part of a picture sequence, and the frame converter is configured to vary a frame rate of the picture sequence by inserting the intermediate frame therein such that one or more of a motion blur and a judder in the picture sequence is reduced.

In at least one example embodiment, the noise filter is configured to temporally filter the unfiltered second frame based on a global motion estimate without partitioning the unfiltered second frame.

In at least one example embodiment, the noise filter includes a spatial filter configured to spatially filter the unfiltered second frame to generate a spatial filtered frame; a temporal filter configured to temporally filter an unfiltered first frame to generate a temporal filtered frame, the unfiltered first frame being an unfiltered version of the filtered first frame; and a spatial-temporal filter configured to generate the filtered second frame based on the spatial filtered frame and the temporal filtered frame.

In at least one example embodiment, the spatial-temporal filter is configured to provide the filtered second frame to the buffer as a next filtered first frame, and the noise filter is configured to reclusively perform the temporally and spatially filtering thereon.

### BRIEF DESCRIPTION OF THE DRAWINGS

The above and other features and advantages of example embodiments of the inventive concepts will become more apparent by describing in detail example embodiments thereof with reference to the attached drawings in which:

FIG. 1 is a flowchart illustrating a method of removing noise of an image signal according to an example embodiment of the inventive concepts;

FIG. 2 is a flowchart illustrating a method of removing noise of an image signal according to another example embodiment of the inventive concepts;

Fig. 3 is a block diagram illustrating an image processing device according to an example embodiment of the inventive concepts; and

FIG. 4 is a block diagram illustrating an image processing device according to another example embodiment of the inventive concepts.

### DETAILED DESCRIPTION OF THE EMBODIMENTS

Advantages and features of example embodiments of the inventive concepts may be understood more readily by reference to the following detailed description of some example embodiments and the accompanying drawings. Example embodiments of the inventive concepts may, however, be embodied in many different forms and should not be construed as being limited to the example embodiments set forth herein. Rather, these example embodiments are provided so that this disclosure will be thorough and complete and will fully convey the concept of the inventive concept to those skilled in the art, and the present inventive concept will only be defined by the appended claims. Like reference numerals refer to like elements throughout the specification.

The terminology used herein is for the purpose of describing particular example embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments of the inventive concepts.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

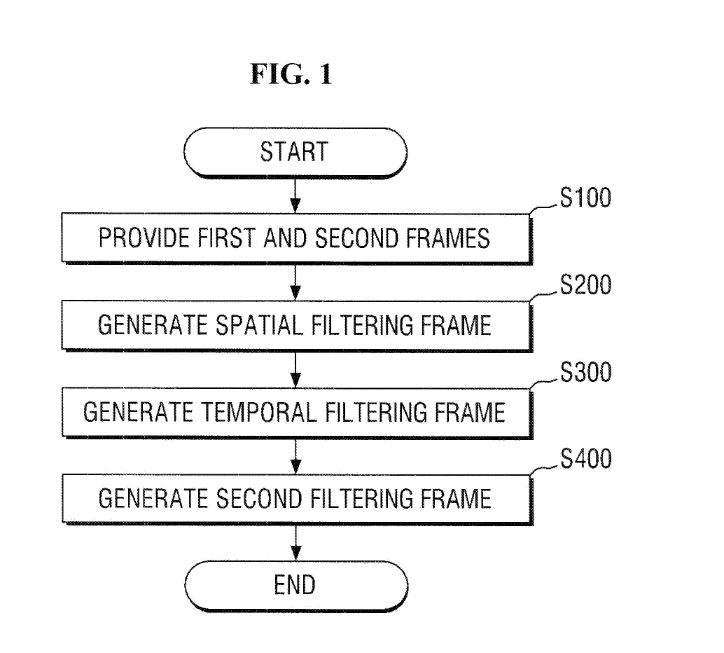

FIG. 1 is a flowchart illustrating a method of removing noise of an image signal according to an example embodiment of the inventive concepts.

Referring to FIG. 1, first and second frames are provided (S100). The first and second frames are frames including an image signal. The first frame and the second frame are each one frame and the second frame is a frame following the first frame. For example, when the first frame is the n^{th} frame, the second frame may be the n+1^{th} frame (where n is a positive number).

Next, a spatial filtering frame is generated by performing spatial filtering on the second frame (S200). The spatial filtering is an image processing technique that filters an image signal in the spatial domain using pixel values of frames. Using spatial filtering, it is possible to remove noise included in the second frame.

The spatial filtering may be performed by any spatial filtering method known to one skilled in the art to determine each of the pixel values in frames, for example, using a 3×3 or 5×5 mask, but example embodiments are not limited thereto.

Next, a temporal filtering frame is generated by performing temporal filtering on the first frame (S300).

The temporal filtering is an image processing technique that filters temporally among a plurality of frames having image signals. In other words, the temporal filtering is to temporally identify and filter a noise characteristic, using the first frame and the second frame. The temporal filtering operates to filter pixels in a temporal direction.

Noise included in the second frame may be removed via the temporal filtering. In detail, the temporal filtering may be performed using a temporal weight. The temporal weight may be obtained by measuring similarities between the first and second frames

The temporal weight may include a global motion vector (GMV) weight between the first and second frames and local motion vector (LMV) weight between the first and second frames.

The GMV weight may be determined using Equation (1).

αglobal=Dsim(F₁(i, j)∈(|i-gmv_{y}|≦1, |j-gmvₓ|≦1), F₂(i, j )∈(|i|≦1, |j|≦1) Eq. (1)

where, αglobal is GMV weight, Dsim is similarity between two frames, F₁ is the first frame, F₂ is the second frame, (i, j) is the coordinate of a pixel, gmv_{y} and gmvₓ are global motion vectors, and lmv_{y} and lmvₓ are local motion vectors.

The LMV weight may be determined using Equation (2).

αlocal=Dsim(F₁(i, j)∈(|i-lmvy|≦1, |j-lmvx|≦1), F₂(i,j)∈(|i|≦1, |j|≦1)) Eq. (2)

where, αglobal is LMV weight, Dsim is similarity between two frames, F₁ is the first frame, F₂ is the second frame, (i, j) is the coordinate of a pixel, gmvy and gmvx are global motion vectors, and lmvy and lmvx are local motion vectors.)

As seen from Equations 1 and 2, the higher the similarity between the result of applying the GMV to the first frame and the second frame, the larger the GMV weight and the higher the similarity between the result of applying the LMV to the first frame and the second frame, the larger the LMV weight.

An example of a method for determining the GMV weight and LMV weight has been described using a 3×3 unit, however, example embodiments of the inventive concepts are not limited thereto and filtering may be performed in various units including 5×5 and 88×8.

The order of the generation of a spatial filtering frame (S200) and the generation of a temporal filtering frame (S300) may be changed. For example, it is possible to generate a temporal filtering frame and then a spatial filtering frame, or to simultaneously generate a temporal filtering frame and a spatial filtering frame.

Next, a second filtering frame is generated by obtained by filtering the second frame (S400).

It is possible to use the spatial filtering frame obtained by performing the spatial filtering and the temporal filtering frame obtained by performing the temporal filtering in order to generate the second filtering frame. The second filtering frame may be generated by Equation (3).

F′₂(i, j)=(Fₜₑₘₚₒᵣₐₗ(i, j)+(1−min(αglobal, αlocal))·Fₛₚₐₜᵢₐₗ(i, j)+αuser·F₂(i, j))/αtotal Eq. (3)

where, F′2 is the second filtering frame, Fₜₑₘₚₒᵣₐₗ (i, j) is a temporal filtering frame satisfying Fₜₑₘₚₒᵣₐₗ(i, j)=αglobal·F₁(i-gmvy, j-gmvx)+αlocal·F₁(i-lmvy, j-lmvx), F₁ is the first frame, F₂ is the second frame, Fₛₚₐₜᵢₐₗ is a spatial filtering frame, αglobal is GMV weight, αlocal is LMV weight, αuser is an arbitrary weight, αtotal is the sum of the αglobal, αlocal, (1−min (αglobal, αlocal)), and αuser, and min (αglobal, αlocal) is the minimum value of αglobal and αlocal.

As illustrated in Equation 3, the second filtering frame is determined using both the temporal filtering and the spatial filtering. Therefore, the noise included in the second frame can be effectively removed, in comparison to separately using the temporal filtering or the spatial filtering.

The weight given to the spatial filtering frame and the weight given to the temporal filtering frame in generating the second filtering may depend on the GMV weight and the LMV weight. In detail, the weight of the temporal filtering frame may be determined by the GMV weight and the LMV weight. Further, the weight of the spatial filtering frame may be determined by the smaller of the GMV weight and the LMV weight. As discussed above, the GMV weight and the LMV weight depend on how much the first frame is similar to the second frame and which one of the spatial filtering frame and the temporal filtering frame is given weight in finding the second filtering frame may depend on the GMV weight and the LMV weight.

The second frame may be additionally used for finding the second filtering frame. How much weight the second frame is given depends on an arbitrary (or, alternatively, a desired) weight αuser and the arbitrary weight αuser may be determined by a user. However, example embodiments are not limited thereto, and for example, αuser may depend on the GMV weight and/or the LMV weight.

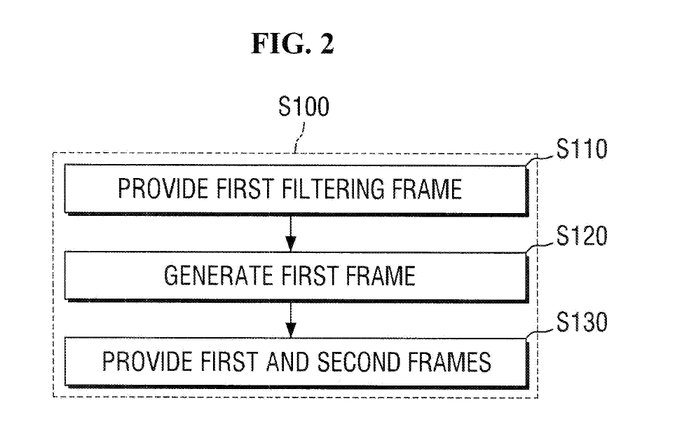

FIG. 2 is a flowchart illustrating a method of removing noise of an image signal according to another example embodiment of the inventive concepts.

Unlike the method described with reference to FIG. 1, in the method illustrated in FIG. 2, the first frame is generated rather than provided.

A first filtering frame is provided (S110).

Next, to the determine the second frame, using equation 3, described above, the first frame is needed. Therefore, the first filtering frame is converted into the first frame (S120). When the value, such as the GMV and the LMV, used for finding the first filtering frame are provided, the first filtering frame may be converted back into the first frame.

After the first frame is generated, the first frame and the second frame are provided (S130).

After provided with the first frame and the second frame, the method of removing noise of an image signal is the same as those described with reference to FIG. 1 and thus the detailed description is not provided.

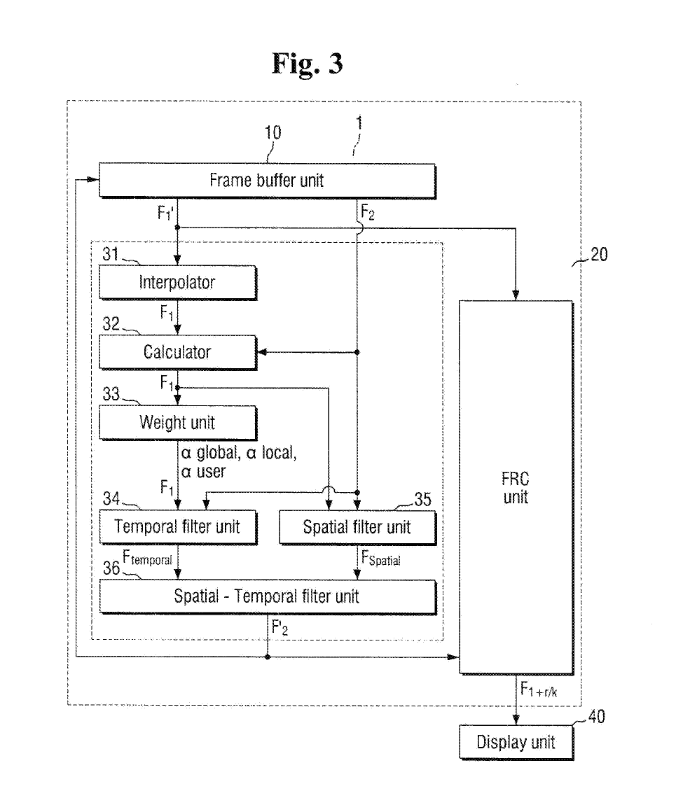

FIG. 3 is a block diagram illustrating an image processing device according to an example embodiment of the inventive concepts.

Referring to FIG. 3, an image processing device 1 may include a frame buffer unit 10, a frame rate conversion (FRC) unit 20, and a noise filter unit 30.

The frame buffer unit 10 stores frames and provides the stored frames to the FRC unit 20 and the noise filter unit 30. Further, the frame buffer unit 10 may store the GMV, the LMV, and the like of each of the frames and provide the GMV, the LMV, and the like to the noise filter unit 30.

The GMV, the LMV, and the like of each of the frames, stored in the frame buffer unit 10, may be information previously provided to the frame buffer 10 from the noise filter unit 30 or the FRC unit 20.

The FRC unit 20 performs frame rate conversion. In detail, the FRC unit 20 is provided with a first filtering frame F′₁ from the frame buffer unit 10 and a second filtering frame F′₂ from the noise filter unit 30. Further, the FRC unit 20 generates an intermediate frame _{F1+r/K} to be inserted between the first filtering frame F′₁ and the second filtering frame F′₂ (where, K is a natural number satisfying K>0 and r is a natural number satisfying 0≦r≦K). The number of the intermediate frames F_{1+r/K} to be generated is not limited and may depend on the image quality, the kinds of images, or the state of a display unit 40.

The FRC unit 20 minimizes motion blur generated on the screen while generating the intermediate frame between the first frame F₁ and the second frame F₂. However, when the intermediate frame F_{1+r/K} is generated by using the first frame F₁ and the second frame F₂, since noise is included into the first frame F₁ and the second frame F₂, noise is included into the intermediate frame F_{1+r/K}, and thus, a clear image may not be generated. Therefore, the FRC unit 20 generates the intermediate frame F_{1+r/K} using the first filtering frame F′₁ and the second filtering frame F′₂. The first filtering frame F′₁, the second filtering frame F′₂, and the intermediate frame F_{1+r/K} are provided to the display unit 40.

After the display unit 40 is provided with the first filtering frame F′₁, the second filtering frame F′₂, and the intermediate frame F_{1+r/K}, the display unit 40 may perform signal processing on the first filtering frame F′₁, the second filtering frame F′₂, and the intermediate frame F_{1+r/K}, and then, display the first filtering frame F′₁, the second filtering frame F′₂, and the intermediate frame F_{1+r/K}.

The noise filter unit 30 functions as removing noise from a provided original frame, and generates a frame filtered with the noise removed. For example, it is possible to generate the first filtering frame F′₁ with noise removed from the first frame F₁ and the second filtering frame F′₂ with noise removed from the second frame F₂. The second frame F₂ is an image frame following the first frame F₁. For example, when the first frame F₁ is the n^{th} frame, the second frame F₂ may be the n+1^{th} frame (where, n is a positive number). The noise filter unit 30 may remove noise, using both of spatial filtering and temporal filtering.

The noise filter unit 30 may include an interpolator 31, a calculator 32, a weight unit 33, a temporal filter unit 34, a spatial filter unit 35, and a spatial-temporal filter unit 36.

The interpolator 31 is provided with the first filtering frame F′₁ from a frame buffer unit 10 and converts the first filtering frame F′₁ into a first frame F₁. Since the first frame F₁ is needed to generate a second filtering frame F′₂, the interpolator 31 converts the first filtering frame F′₁ into the first frame F₁. The interpolator 31 needs a GMV, an LMV, and the like in order to generate the first frame F₁ from the first filtering frame F′₁, and the interpolator 31 may be provided with the GMV, the LMV, and the like from the frame buffer unit 10.

The first frame F₁ obtained by the conversion of the interpolator 31 is provided to the calculator 32. The calculator 32 may measure the noise included in the provided first frame F₁ and second frame F₂. The calculator 32 may measure noise included in each pixel, but example embodiments of the inventive concepts are not limited thereto, and for example, it is possible to calculate noise in a 3×3 or 5×5 block unit. The calculator 32 can obtain, for example, standard deviation (STD) of noise or sum of absolute difference (SAD) of noise in a pixel or block unit. However, the STD and SAD are only examples, and in addition the STD and SAD, other values can be obtained.

The weight unit 33 is provided with the first frame F₁ and the second frame F₂ from the calculator 32 and the noise measurement values measured in the calculator 32. The weight unit 33 obtains the weight of the GMV weight (αglobal) and the weight of the LMV (αlocal), which are temporal weights, by measuring the similarity between the first frame F₁ and the second frame F₂. The GMV weight, αglobal, can be obtained from Equation (1) disclosed above and the LMV weight, αlocal, can be obtained from Equation (2) disclosed above. The weight unit 33 may include arbitrary (or otherwise, a desired) weight, αuser. The arbitrary weight, αuser may be directly inputted by a user or may be determined in accordance with the GMV weight, αglobal, and/or the LMV weight, αlocal.

The temporal filter unit 34 is provided with the first frame F₁, the GMV weight, αglobal, and the LMV weight, αlocal from the weight unit 33 and the second frame F₂ from the frame buffer unit 10. The temporal filter unit 34 generates a temporal filtering frame Fₜₑₘₚₒᵣₐₗ by performing temporal filtering on the first frame F₁. The temporal filtering may be performed, using the GMV weight, αglobal, the LMV weight, αlocal, which are temporal weights. The temoporal filter unit 34 may determine the temporal filtering frame Fₜₑₘₚₒᵣₐₗ using Equation (4).

Fₜₑₘₚₒᵣₐₗ(i, j)=αglobal·F₁(i-gmv_{y}, j-gmvₓ)+αlocal·F₁(i-lmv_{y}, j-lmvₓ) Eq. (4)

The spatial filter unit 35 generates a spatial filtering frame Fₛₚₐₜᵢₐₗ by performing spatial filtering on the second frame F₂. The spatial filter unit 35 is provided with the values measured by the calculator 32, for example, the STD, and the second frame F₂ from the frame buffer unit 10.

The spatial-temporal filter unit 36 is provided with the spatial filtering frame Fₛₚₐₜᵢₐₗ from the spatial filter unit 35 and the temporal filtering frame Fₜₑₘₚₒᵣₐₗ from the temporal filter unit 34. Further, using both of the spatial filtering and the temporal filtering, the spatial-temporal filter unit 36 filters noise from second frame F₂ to generate a second filtering frame F′₂.

The spatial-temporal filter unit 36 may be obtained from Equation (3) disclosed above and may be provided with the GMV weight αglobal, the LMV weight αlocal, and the arbitrary weight αuser from the weight unit 33. The second filtering frame F′₂ generated by the spatial-temporal filter unit 36 is provided to the FRC unit 20 and the FRC unit 20 generates an intermediate frame F_{1+r/K}, using the second filtering frame F′₂.

The second filtering frame F′₂ may be also provided to the frame buffer unit 10. The frame buffer unit 10 can provide the second filtering frame F′₂, which it has stored, when the noise filter unit 30 is operated to remove noise in a third frame (for example, n+2^{th} frame), and allows the FRC unit 20 to generate an intermediate frame between the second frame F₂ and the third frame by providing the second filtering frame F′₂ to the FRC unit 20.

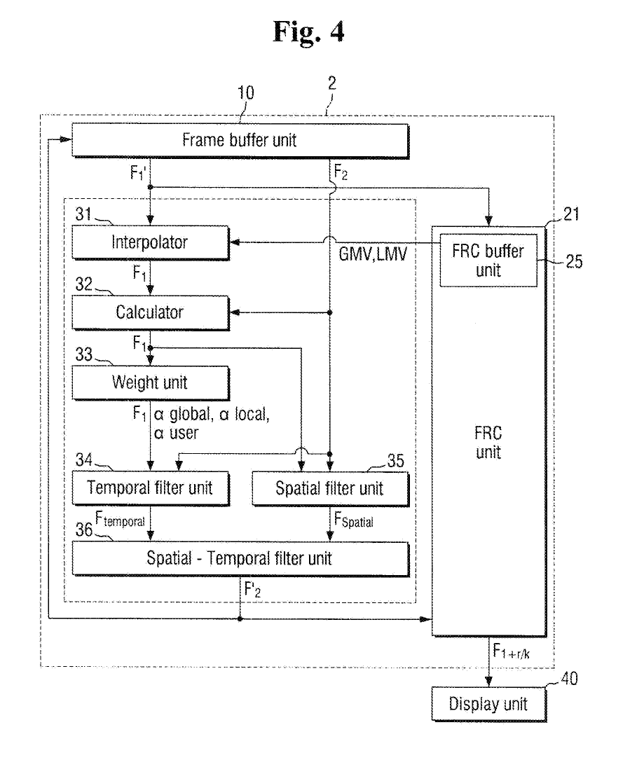

FIG. 4 is a block diagram illustrating an image processing device according to another example embodiment of the inventive concepts.

Referring to FIG. 4, an image processing device 2 may include an FRC unit 21 that includes an FRC buffer unit 25. The FRC buffer unit 25 stores GMVs and LMVs of the frames. The GMVs and LMVs stored in the FRC buffer unit 25 may be used for generating an intermediate frame F_{1+r/K}.

Further, the GMVs and LMVs stored in the FRC buffer unit 25 may be provided to an interpolator 31. The interpolator 31 may use the GMVs and the LMVs provided from the FRC buffer unit 25, when converting a first filtering frame F′₁ into a first frame F₁.

Other aspects of the image processing device 2 are the same as the image processing device 1, therefore, for the sake of brevity repeated description is omitted.

The foregoing is illustrative of example embodiments of the inventive concepts and is not to be construed as limiting thereof. Although a few example embodiments of the inventive concepts have been described, those skilled in the art will readily appreciate that many modifications are possible in the example embodiments without materially departing from the novel teachings and advantages of the inventive concepts. Accordingly, all such modifications are intended to be included within the scope of example embodiments of the inventive concepts as defined in the claims. Therefore, it is to be understood that the foregoing is illustrative of example embodiments of the inventive concepts and is not to be construed as limited to the specific example embodiments disclosed, and that modifications to the disclosed example embodiments, as well as other example embodiments, are intended to be included within the scope of the appended claims. Example embodiments of the inventive concepts are defined by the following claims, with equivalents of the claims to be included therein.

1-6. (canceled)

7. An image processing device configured to process an image signal, the image signal including at least a first frame and a second frame, the image processing device comprising:
a frame rate conversion (FRC) unit configured to generate an intermediate frame in a sequence between a first filtering frame and a second filtering frame; and
a noise filter unit configured to generate the second filtering frame by removing noise in the second frame, using both of temporal filtering and spatial filtering.

8. The device of claim 7, wherein the first filtering frame and the second filtering frame are generated, using the first frame and the second frame, respectively, and
the first frame is a n^{th} frame in a sequence and the second frame is a n+1^{th} frame in the sequence, wherein n is a natural number.

9. The device of claim 7, wherein the noise filter unit comprises:
a spatial filter unit configured to spatially filter the second frame to generate a spatial filtering frame;
a temporal filter unit configured to temporally filter the first frame to generate a temporal filtering frame; and
a spatial-temporal filter unit configured to generate the second filtering frame from the spatial filtering frame and the temporal filtering frame.

10. The device of claim 9, wherein the noise filter unit further comprises:
a weight unit configured to obtain a temporal weight by measuring a similarity between the first frame and the second frame, and wherein
the temporal filter unit is configured to temporally filter the first frame based on the temporal weight.

11. The device of claim 10, wherein the temporal weight includes a global weight associated with a global motion vector (GMV) between the first and second frames, and a local weight associated with a local motion vector (LMV) between the first and second frames, and
the temporal filter unit is configured to temporally filter the first frame further based on the GMV weight and the LMV weight.

12. The device of claim 11, wherein the spatial-temporal filter unit generates the second filtering frame based on:
F′₂(i, j)=(Fₜₑₘₚₒᵣₐₗ(i, j)+(1−min(αglobal, αlocal))·Fₛₚₐₜᵢₐₗ(i, j)+αuser·F₂(i, j))/αtotal
where F′₂ is the second filtering frame, Fₜₑₘₚₒᵣₐₗ is the temporal filtering frame satisfying Fₜₑₘₚₒᵣₐₗ(i, j)=αglobal·F₁ (i-gmvy, j-gmvx)+αlocal·F₁(i-lmvy, j-lmvx), F₁ is the first frame, F₂ is the second frame, Fₛₚₐₜᵢₐₗ is the spatial filtering frame, αglobal is the GMV weight, αlocal is the LMV weight, αuser is a desired weight, and αtotal is the sum of the αglobal, the αlocal, (1−min (αglobal, αlocal)), and αuser, and min (αglobal, αlocal) is a minimum value of the global and the αlocal.)

13. The device of claim 9, wherein the noise filter unit further comprises:
an interpolator configured to convert a first filtering frame into the first frame, and provide the first frame to the weight unit, the first filtering frame being a previously filtered frame with noise therein removed.

14. The device of claim 13, wherein the FRC unit is configured to generate the intermediate frame based on the first filtering frame and the second filtering frame.

15. An image display device comprising:
the image processing device of claim 7; and
a display unit configured to,
perform signal processing on one or more of the first filtering frame, the second filtering frame and the intermediate frame, and
display one or more of the first filtering frame, the second filtering frame and the intermediate frame on a screen.

16. An image processing device comprising:
a buffer configured to store a filtered first frame and an unfiltered second frame;
a noise filter configured to temporally and spatially filter the unfiltered second frame to generate a filtered second frame; and
a frame rate converter configured to generate an intermediate frame in a sequence between the filtered first frame and the filtered second frame.

17. The image processing device of claim 16, wherein the sequence of the filtered first frame and the filtered second frame are part of a picture sequence, and the frame converter is configured to vary a frame rate of the picture sequence by inserting the intermediate frame therein such that one or more of a motion blur and a judder in the picture sequence is reduced.

18. The image processing device of claim 16, wherein the noise filter is configured to temporally filter the unfiltered second frame based on a global motion estimate without partitioning the unfiltered second frame.

19. The image processing device of claim 16, wherein the noise filter comprises:
a spatial filter configured to spatially filter the unfiltered second frame to generate a spatial filtered frame;
a temporal filter configured to temporally filter an unfiltered first frame to generate a temporal filtered frame, the unfiltered first frame being an unfiltered version of the filtered first frame; and
a spatial-temporal filter configured to generate the filtered second frame based on the spatial filtered frame and the temporal filtered frame.

20. The image processing device of claim 19, wherein the spatial-temporal filter is configured to provide the filtered second frame to the buffer as a next filtered first frame, and the noise filter is configured to recursively perform the temporally and spatially filtering thereon.
